(19) United States
(12) Patent Application Publication
(10) Pub. No.: US 2025/0165801 A1
(43) Pub. Date: May 22, 2025

(54) SYSTEMS AND METHODS FOR FEATURE DROPOUT KNOWLEDGE DISTILLATION

(71) Applicant: Datum Point Labs Inc., Jackson, WY (US)

(72) Inventors: Bokyeung Lee, Seoul (KR); Hanseok Ko, Seoul (KR); Bonhwa Ku, Seoul (KR)

(21) Appl. No.: 18/954,233

(22) Filed: Nov. 20, 2024

Related U.S. Application Data
(60) Provisional application No. 63/601,508, filed on Nov. 21, 2023.

(51) Int. Cl. G06N 3/096; G06N 3/0455

(52) U.S. Cl. CPC G06N 3/096; G06N 3/0455

(57) ABSTRACT

Embodiments described herein provide systems and methods for knowledge distillation. A system encodes features from a student model and a teacher model to provide principal components. The principal components may be decoded to provide decoded components. Logits may also be output by the student and teacher models. A loss function may be computed based on the principal components, decoded components, and logits. Parameters of the student model may be updated based on the loss function.

### TECHNICAL FIELD

The embodiments relate generally to systems and methods for knowledge distillation.

### BACKGROUND

In machine learning, knowledge distillation allows for one model to distill knowledge from another model. Generally, knowledge from a larger model is distilled into a smaller model, which in the process may lose some accuracy, but maintain sufficient accuracy to be useful, while requiring less memory and/or computation resources. Different models may have different structures, however, and these structural differences make knowledge distillation more difficult, as the structural components may represent redundant elements. Therefore, there is a need for improved systems and methods for knowledge distillation.

### BRIEF DESCRIPTION OF THE DRAWINGS

FIG. 1 illustrates an exemplary framework for knowledge distillation, according to some embodiments.

FIG. 2 is a simplified diagram illustrating a computing device implementing the framework described in FIG. 1, according to some embodiments.

FIG. 3 is a simplified block diagram of a networked system suitable for implementing the framework described in FIG. 1 and other embodiments described herein.

FIG. 4 illustrates knowledge distillation, according to some embodiments.

FIG. 5 is a simplified diagram illustrating a neural network structure, according to some embodiments.

FIG. 6 illustrates a chart of exemplary performance of embodiments described herein.

### DETAILED DESCRIPTION

In machine learning, knowledge distillation allows for one model to distill knowledge from another model. Generally, knowledge from a larger model is distilled into a smaller model, which in the process may lose some accuracy, but maintain sufficient accuracy to be useful, while requiring less memory and/or computation resources. Different models may have different structures, however, and these structural differences make knowledge distillation more difficult, as the structural components may represent redundant elements.

One problem with existing knowledge distillation methods is the critical problem of bridging the “capacity gap” when transferring knowledge from complex Transformer models to lightweight convolutional neural networks (CNNs). This capacity gap arises due to structural and inductive bias differences between these model types, hindering the effective transfer of knowledge.

Embodiments described herein provide systems and methods for feature dropout knowledge distillation. In some embodiments, knowledge distillation is performed using both feature dropout distillation and logit dropout distillation. Feature dropout distillation is based on a sparse principal component analysis framework and is composed of two encoder-decoder architectures, one for the teacher model and one for the student model. The primary objective of these encoders is to extract non-intrinsic knowledge from the features of each network while eliminating redundant elements, including structural information. Dropout is employed in the encoder to generate a set of summary indices, known as principal components, representing non-intrinsic knowledge.

Logit Dropout Distillation focuses on creating probability distributions from sparse features of both the teacher and student models, leveraging dropout during knowledge distillation training. Unlike previous dropout-based distillation methods, the invention utilizes unprocessed outputs from both models in the training stage. The student model gains principled uncertainty estimates for input images as the target distribution, contributing to improved knowledge transfer.

In extensive experiments, embodiments described herein showcase superior performance, particularly when transferring knowledge from Transformers to convolutional neural networks (CNNs). It not only outperforms baseline models but also demonstrates its effectiveness in CNN-to-CNN and Transformer-to-Transformer knowledge transfer scenarios. Moreover, embodiments described herein challenge the conventional belief that centered kernel alignment (CKA) similarity between features guarantees student performance improvement, offering a fresh perspective on the relationship between feature alignment and model performance. Overall, methods described herein provide improvements in deep learning and have wide-ranging applications, particularly in computer vision, where it can significantly enhance model generalization and performance.

Embodiments described herein provide a number of benefits. For example, methods described herein provide a solution to mitigate the “capacity gap” challenge and enhance knowledge distillation, allowing efficient and accurate knowledge transfer between disparate model architectures. Methods described herein can be used to efficiently transfer knowledge from large-scale Transformer models, like those used in computer vision, to smaller and more lightweight CNN models. This can enable real-world applications where computational resources are limited, such as edge devices like mobile phones and robots, due to the reduced memory and/or computation requirements. Methods described herein are not limited to Transformer-to-CNN knowledge distillation but can also be used in other scenarios, such as CNN-to-Transformer, CNN-to-CNN and Transformer-to-Transformer knowledge distillation (KD). This flexibility allows researchers and practitioners to adapt the method to various model architectures and domains. Methods described herein can be applied to various tasks, such as computer vision, NLP, data processing and audio signal processing, allowing CNN models to benefit from the powerful generalization ability of Transformer models. This can lead to improved performance in scenarios where compact models are required.

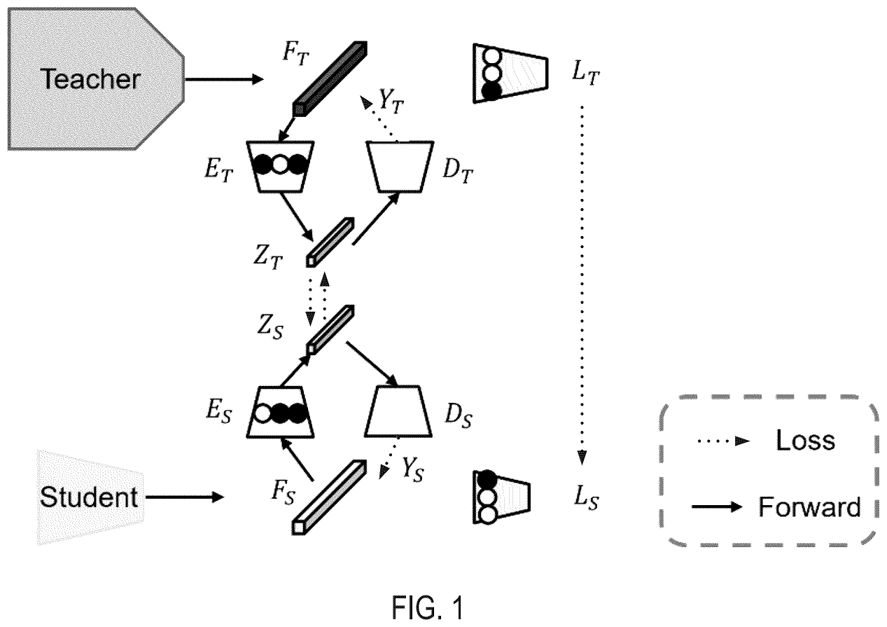

FIG. 1 illustrates an exemplary framework 100 for knowledge distillation, according to some embodiments. Framework 100 illustrates knowledge distillation from a teacher model to a student model. The teacher model and student model may be the same type of model, or different types of models, and may be of different sizes. For example, the teacher model may be a large transformer model, and the student model may be a relatively smaller convolutional neural network (CNN) model.

As illustrated, feature dropout distillation leverages a sparse principal component analysis framework to eliminate structural information from the latent features of both the teacher and student models. It projects these features into a principal component space, effectively removing redundancy in structural knowledge. This process results in a more efficient and valuable knowledge transfer, as the student model can learn from the teacher without inheriting irrelevant structural information. Logit dropout distillation complements this by introducing uncertainty in the logits of both teacher and student models. By applying dropout in the classifiers, the method encourages the student to learn from the teacher's logits without losing its intrinsic knowledge, leading to more effective and focused knowledge transfer. The method's flexibility in customizing the training process using hyperparameters and its use of the centered kernel alignment metric for dropout rate adjustment make it a versatile and innovative approach to knowledge distillation in deep learning, particularly in scenarios with varying capacity gaps between teacher and student models.

As illustrated, F_{T} and F_{S} are the features of the teacher and student. E_{T} and E_{S} are encoders of the teacher and student. D_{T} and D_{S} are decoders of the teacher and student. Z_{T} and Z_{S} are principal components of the teacher and student. L_{T} and L_{S} are logits of the teacher and student. D_{KL} denotes KL divergence and L_{Ce} is cross-entropy loss function for the student. λₗ, λ_{recon} and λ_{fd} are hyper-parameters. Accordingly, one or more loss functions may be computed by which parameters of the student model may be updated via backpropagation. The loss may be computed as such:

$${L}_{recon} = {‖ {F}_{T} - {D}_{T} ( {E}_{T} ( {F}_{T} ) ) ‖}_{2}^{2} + {‖ {F}_{S} - {D}_{S} ( {E}_{S} ( {F}_{T} ) ) ‖}_{2}^{2} \\ {L}_{fd} = {‖ {Z}_{T} - {Z}_{S} ‖}_{2}^{2} \\ {L}_{ld} = {D}_{KL} ( {L}_{S} ‖ {L}_{T} ) \\ {L}_{total} = {λ}_{l} {L}_{ce} + ( 1 - {λ}_{l} ) {L}_{ld} + {λ}_{recon} {L}_{recon} + {λ}_{fd} {L}_{fd}$$

As shown in the loss equations, a total loss (Lₜₒₜₐₗ), the different loss functions may be combined with weights controlled by hyperparameters.

In some embodiments, an aim is to reduce specific information caused by structural differences between the teacher and student networks in the KD training stage. For example, if specific knowledge occupies a large portion of the teacher's feature maps, the student network ends up adopting a strategy of simply mimicking rather than learning. Similarly, when the student's features hold specific knowledge, the student may forget this information during the KD training, as the teacher lacks the same specific knowledge. These factors significantly contribute to the performance degradation of the student network. To suppress specific knowledge generated by the network structure, some embodiments employ the sparse principal component analysis (PCA) framework. Define X∈ [symbol] ^{n×p} as a data matrix. Sparse PCA with sparse penalty desired on W=[w₁, . . . , wₖ] solves the following problem:

$$\hat{W} , \hat{P} = \frac{arg min}{W , P} {‖ X - {XWP}^{T} ‖}^{2} + P ( w ) \qquad ( 1 )$$

where W∈ [symbol] ^{p×k} is component weights, P∈ [symbol] ^{p×k} denotes the component [symbol] loadings matrix, which expresses the strength of the connection between the variables, and P(⋅) is a particular penalty term that imposes sparsity on the component weights i.e., ridge and lasso penalties. A goal of sparse PCA is to enhance interpretability by assigning zero coefficients to many variables that are irrelevant to the principal components.

In Transformer-to-CNN feature distillation, feature maps FT and FS from the teacher and student networks can encompass both general and specific knowledge. When conducting distillation between heterogeneous networks, such as Transformer-to-CNN feature distillation, compelling the transfer of specific knowledge stemming from the teacher's unique structure onto the students may not be the most suitable approach.

Moreover, if the feature maps containing the student's specific knowledge become too similar to the teacher's feature maps through distilling, lacking the student's specific knowledge, it can result in the loss of the student's specific knowledge. Conversely, an effective KD strategy in some embodiments involves preventing the passage of specific knowledge from the teacher network to the student network while preserving the student's specific knowledge. To implement this strategy, in some embodiments, the sparse PCA method is introduced to feature KD. Using the sparse PCA, the principal components ZT and ZS of FT and FS, feature maps of the student and teacher network, respectively can be extracted. When feature distillation is performed in the principal component space rather than the original feature map space, it allows the student to capture general knowledge from the teacher network while excluding specific knowledge that is not useful to the student.

To solve the Eq. (1), a denoising autoencoder mechanism may be used. FIG. 1 illustrates the framework of our proposed DropKD, comprising a Transformer-based teacher, a CNN-based student, two encoders E, and two decoders D. The teacher and student generate latent features F_{T}∈ [symbol] ^{n×d}^{ₜ} and F_{S}∈ [symbol] ^{n×d}^{ₛ}, which have general knowledge and specific information. n is the number of minibatch, dₜ and dₛ are the number of channels of the features from teacher and student. To acquire the principal component, F_{T} and Fₛ are projected into Z_{T}∈ [symbol] ^{n×d}^{_{z}} and Z_{S} ∈ [symbol] ^{n×d}^{_{z}} through the encoders E_{T} and E_{S}, which are strongly related to W. The encoded vector Z is considered the principal component, and d_{z} denotes the number of channels of the projected dimension.

$${Z}_{T} = {E}_{T} ( {F}_{T} , {rf}_{T} ) \qquad ( 2 )$$

$${Z}_{S} = {E}_{S} ( {F}_{S} , {rf}_{S} ) \qquad ( 3 )$$

where rf_{T} and rf_{S} denote the dropout rate of two encoders (E_{T} and E_{S}), and each encoder consists of two linear layers. However, two principal components (Z_{T} and Z_{S}) from two networks still inevitably contain specific information if the sparse constraint does not follow (r_{T}=0, r_{S}=0). To inject sparsity into two encoders, this corresponds to the second term of Eq. (1), a dropout layer may be inserted in the encoder. In training, the dropout makes the encoder a sparse sub-network with high-level sparsity and removes specific information in the features. Z_{T} and Z_{S} are forwarded into each decoder D_{T} and D_{S}, which corresponds to PT. Following the first term of Eq. (1), the reconstruction loss function is added as:

$${ℒ}_{recon} = \frac{1}{{d}_{t}} {‖ {F}_{T} - {D}_{T} ( {Z}_{T} ) ‖}_{2}^{2} + \frac{1}{{d}_{s}} {‖ {F}_{S} - {D}_{S} ( {Z}_{S} ) ‖}_{2}^{2} \qquad ( 4 )$$

Minimizing L_{recon} encourages the encoders to extract general knowledge from conditions resulting from dropout and dimensionality reduction. To transfer the teacher's knowledge to the student, the difference between Z_{T} and Z_{S} may be minimized following as:

$${ℒ}_{fd} = {‖ {Z}_{T} - {Z}_{S} ‖}_{2}^{2} \qquad ( 5 )$$

Optimizing L_{f d} affects two encoders and the student network. The dropout mechanism enhances the generalization of the encoders through iterative training. The two encoders are trained to encourage Z_{T} and Z_{S} to be general feature representations, and the student can acquire the teacher's general knowledge. Additionally, feature dropout distillation enables the two encoders to identify the space for comparing general knowledge within limited information.

In Transformer-to-CNN KD training stage, the specific knowledge in the logit of the teacher may be removed without eliminating specific knowledge in the logit of the student. Consequently, it can lead to the student network forgetting its specific knowledge.

An additional benefit of methods described herein is to ensure that the student acquires general knowledge from the teacher's logits during Transformer-to-CNN KD training while preserving the student's specific knowledge. In some embodiments of logit dropout distillation, a dropout layer is activated in both the teacher's and student's classifiers to introduce uncertainty. The logits of the teacher and student may be computed using the following equation:

$${L}_{T} = {C}_{T} ( {F}_{T} , {rl}_{T} ) \qquad ( 6 )$$

$${L}_{S} = {C}_{S} ( {F}_{S} , {rl}_{S} ) \qquad ( 7 )$$

where C_{T}(⋅) and Cs(⋅) are the classifiers of the teacher and student, and rl_{T} and rl_{S} denote the dropout rates of the classifier of the teacher and student. The logit dropout distillation may be expressed as:

$${ℒ}_{ld} = ( {D}_{KL} ( {L}_{S} ‖ {L}_{T} ) \qquad ( 8 )$$

where D_{KL} denotes the KL-divergence. Dropout serves a dual purpose—it helps eliminate specific knowledge while introducing response variability for both the teacher and student when dealing with the same sample. The uncertainty estimates derived from the teacher's logits serve to guide the student in capturing the general and critical representations present in the teacher's output. Furthermore, the uncertainty estimates calculated from the student's logits enable the student to retain its specific knowledge, as it is not compelled to merely mimic the teacher's logits due to the generalization capability provided by dropout.

The total loss function may be composed of three terms: cross-entropy loss [symbol] _{ce}, logit dropout distillation loss [symbol] _{ld}, reconstruction loss [symbol] _{recong} and feature dropout distillation [symbol] _{fd}. The student network may be trained with the following total loss function:

$${ℒ}_{total} = {λ}_{l} {ℒ}_{ce} + ( 1 - {λ}_{l} ) {ℒ}_{ld} + ( {λ}_{recon} {ℒ}_{recon} + {λ}_{fd} {ℒ}_{fd} \qquad ( 9 )$$

where λₗ, λ_{recon} and λ_{fd} are hyper-parameters, and [symbol] _{ce} denotes the cross-entropy loss function between the outputs of the student and the hard labels for input mini-batches.

In some embodiments a dropout rate serves two essential roles. Firstly, it induces extremely sparse solutions in both encoders and classifiers, sparsity may be regulated by controlling the dropout rate, with sparsity increasing as the dropout rate rises and vice versa. Secondly, it enhances the generalization ability of both encoders and classifiers. Selecting an appropriate dropout rate contributes to the model's generalization capabilities.

The capacity gap between the teacher and student in the Transformer-to-CNN KD scenario can be viewed as the difference in specific knowledge possessed by each. When a large capacity gap exists, it signifies that each specific knowledge component accounts for a substantial portion of the information from the teacher and student. To narrow this gap, the dropout rate may be increased. Conversely, in cases with a smaller capacity gap, a lower dropout rate is preferable to maintain the general and crucial knowledge. In some embodiments, the Centered Kernel Alignment (CKA) method may be utilized to quantify the capacity gap between the teacher and student, and the dropout rate may be set inversely proportional to CKA (manually or automatically).

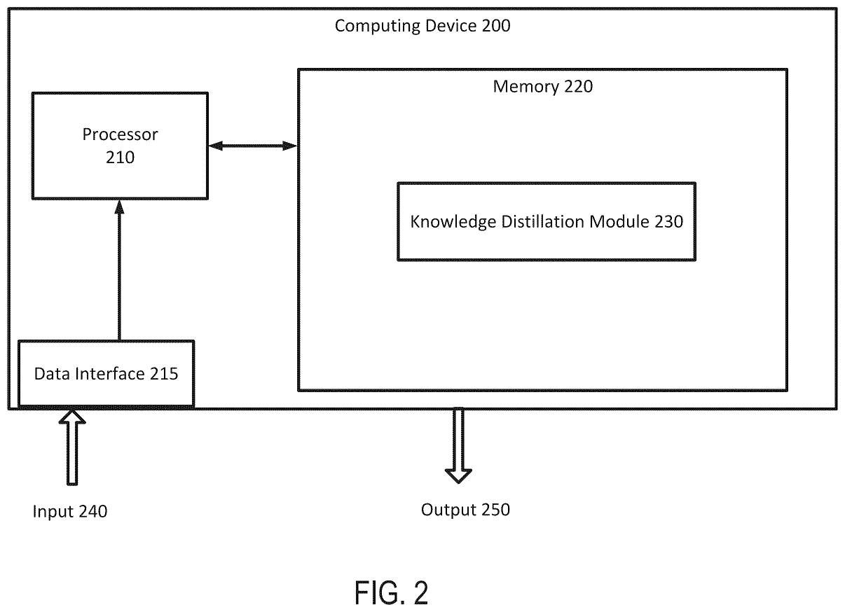

FIG. 2 is a simplified diagram illustrating a computing device 200 implementing the framework described in FIG. 1, according to some embodiments. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for knowledge distillation module 230 that may be used to implement and/or emulate the systems and models, and/or to implement any of the methods described further herein. Knowledge distillation module 230 may receive input 240 such as model parameters, images, text, etc. as part of a training dataset and generate an output 250 which may a loss, updated parameters, images, heat maps, etc.

The data interface 215 may comprise a communication interface, a user interface (such as a voice input interface, a graphical user interface, and/or the like). For example, the computing device 200 may receive the input 240 from a networked device via a communication interface. Or the computing device 200 may receive the input 240, such as images, from a user via the user interface.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

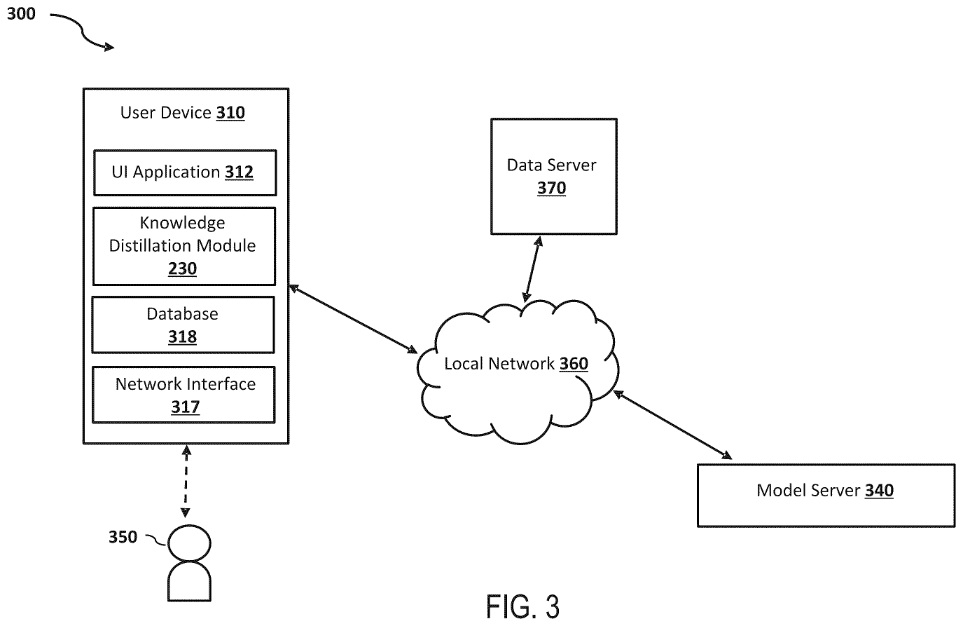

FIG. 3 is a simplified block diagram of a networked system 300 suitable for implementing the framework described in FIG. 1 and other embodiments described herein. In one embodiment, system 300 includes the user device 310 (e.g., computing device 200) which may be operated by user 350, data server 370, model server 340, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

User device 310, data server 370, and model server 340 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over local network 360.

In some embodiments, all or a subset of the actions described herein may be performed solely by user device 310. In some embodiments, all or a subset of the actions described herein may be performed in a distributed fashion by various network devices, for example as described herein.

User device 310 may be implemented as a communication device that may utilize appropriate hardware and software configured for wired and/or wireless communication with data server 370 and/or the model server 340. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and knowledge distillation module 230, which may correspond to executable processes, procedures, and/or applications with associated hardware. For example, the user device 310 may allow a user to select a teacher model and/or a student model for knowledge distillation. In other embodiments, user device 310 may include additional or different modules having specialized hardware and/or software as required.

In various embodiments, user device 310 includes other applications as may be desired in particular embodiments to provide features to user device 310. For example, other applications may include security applications for implementing client-side security features, programmatic client applications for interfacing with appropriate application programming interfaces (APIs) over local network 360, or other types of applications. Other applications may also include communication applications, such as email, texting, voice, social networking, and IM applications that allow a user to send and receive emails, calls, texts, and other notifications through local network 360.

Local network 360 may be a network which is internal to an organization, such that information may be contained within secure boundaries. In some embodiments, local network 360 may be a wide area network such as the internet. In some embodiments, local network 360 may be comprised of direct connections between the devices. In some embodiments, local network 360 may represent communication between different portions of a single device (e.g., a network bus on a motherboard of a computation device).

Local network 360 may be implemented as a single network or a combination of multiple networks. For example, in various embodiments, local network 360 may include the Internet or one or more intranets, landline networks, wireless networks, and/or other appropriate types of networks. Thus, local network 360 may correspond to small scale communication networks, such as a private or local area network, or a larger scale network, such as a wide area network or the Internet, accessible by the various components of system 300.

User device 310 may further include database 318 stored in a transitory and/or non-transitory memory of user device 310, which may store various applications and data (e.g., model parameters) and be utilized during execution of various modules of user device 310. Database 318 may store images, landmark predictions, etc. In some embodiments, database 318 may be local to user device 310. However, in other embodiments, database 318 may be external to user device 310 and accessible by user device 310, including cloud storage systems and/or databases that are accessible over local network 360.

User device 310 may include at least one network interface component 317 adapted to communicate with data server 370 and/or model server 340. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 370 may perform some of the functions described herein. For example, data server 370 may store a training dataset including images, text, etc.

Model server 340 may be a server that hosts the teacher and/or student models described in FIG. 1. Model server 340 may provide an interface via local network 360 such that user device 310 may perform functions relating to the models as described herein (e.g., computing loss functions). Model server 340 may communicate outputs of the teacher and/or student models to user device 310 via local network 360.

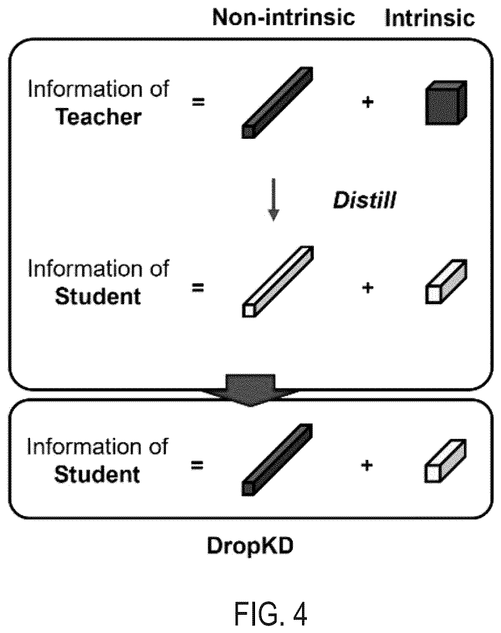

FIG. 4 illustrates knowledge distillation, according to some embodiments. As illustrated, feature dropout distillation as described herein extracts non-intrinsic knowledge from the features of each network while eliminating redundant elements, including structural information. Dropout is employed in the encoder to generate a set of summary indices, known as principal components, representing non-intrinsic knowledge.

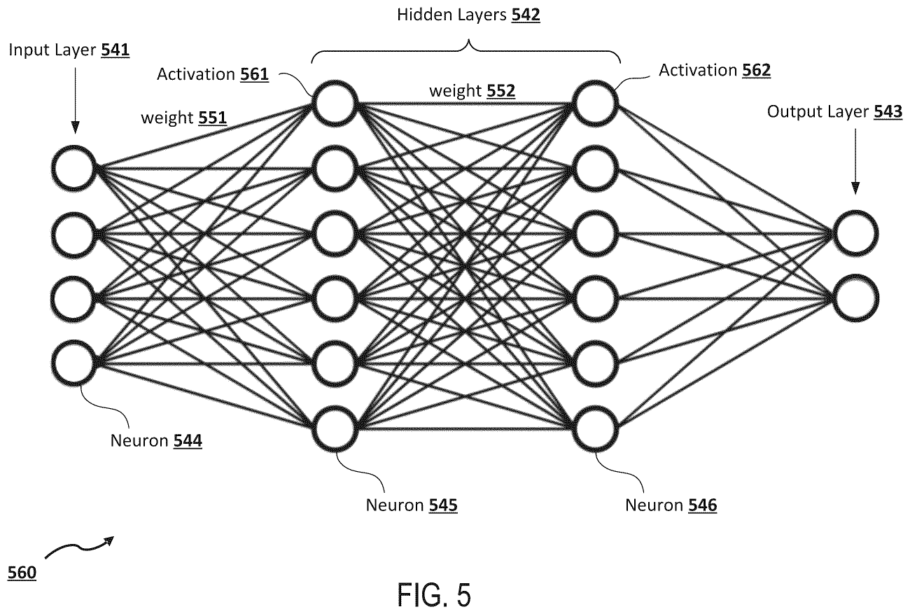

FIG. 5 is a simplified diagram illustrating the neural network structure, according to some embodiments. In some embodiments, the knowledge distillation module 230 may be implemented at least partially via an artificial neural network structure shown in FIG. 5. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data such as training data, user input data, vectors representing latent features, etc. The number of nodes (neurons) in the input layer 541 may be determined by the dimensionality of the input data (e.g., the length of a vector of the input). Each node in the input layer represents a feature or attribute of the input.

The hidden layers 542 are intermediate layers between the input and output layers of a neural network. It is noted that two hidden layers 542 are shown in FIG. 5 for illustrative purpose only, and any number of hidden layers may be utilized in a neural network structure. Hidden layers 542 may extract and transform the input data through a series of weighted computations and activation functions.

For example, as discussed in FIG. 2, the knowledge distillation module 230 may receive input 240 such as images, text, etc. and generate an output 250 which may images, heat maps, etc. A neural network such as the one illustrated in FIG. 5 may be the student model, or the teacher model, or both, or a subset of one or both as described herein. Each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or specific loss functions described herein. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed.

Therefore, the knowledge distillation module 230 may comprise the transformative neural network structure of layers of neurons, and weights and activation functions describing the non-linear transformation at each neuron. Such a neural network structure is often implemented on one or more hardware processors 410, such as a graphics processing unit (GPU).

In one embodiment, the knowledge distillation module 230 may be implemented by hardware, software and/or a combination thereof. For example, the knowledge distillation module 230 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

In one embodiment, the neural network based knowledge distillation module 230 may be trained by iteratively updating the underlying parameters (e.g., weights 551, 552, etc., bias parameters and/or coefficients in the activation functions 561, 562 associated with neurons) of the neural network based on a loss function. For example, during forward propagation, the training data such as document text. The data flows through the network's layers 541, 542, with each layer performing computations based on its weights, biases, and activation functions until the output layer 543 produces the network's output 550. In some embodiments, output layer 543 produces an intermediate output on which the network's output 550 is based.

The output generated by the output layer 543 is compared to the expected output (e.g., a “ground-truth” such as the corresponding ground truth correlation) from the training data, to compute a loss function that measures the discrepancy between the predicted output and the expected output. Given a loss function, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

Parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen text input.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

The neural network illustrated in FIG. 5 is exemplary. For example, different neural network structures may be utilized, and additional neural-network based or non-neural-network based component may be used in conjunction as part of module 230. For example, a text input may first be embedded by an embedding model, a self-attention layer, etc. into a feature vector. The feature vector may be used as the input to input layer 541. Output from output layer 543 may be output directly to a user or may undergo further processing. For example, the output from output layer 543 may be decoded by a neural network based decoder. The neural network illustrated in FIG. 5 and described herein is representative and demonstrates a physical implementation for performing the methods described herein.

Through the training process, the neural network is “updated” into a trained neural network with updated parameters such as weights and biases. The trained neural network may be used in inference to perform the tasks described herein, for example those performed by module 230. The trained neural network thus improves neural network technology in knowledge distillation.

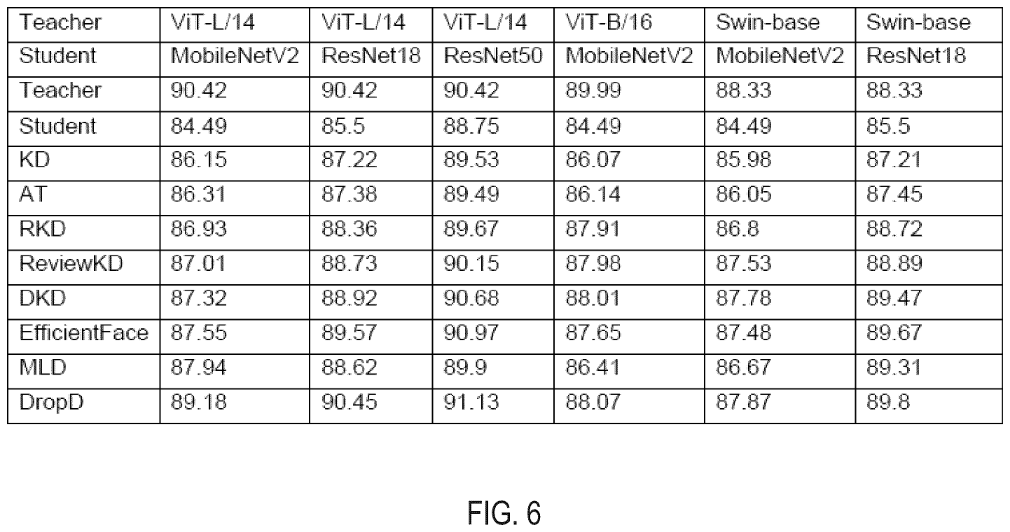

FIG. 6 illustrates a chart of exemplary performance of embodiments described herein. The table in FIG. 6 illustrates exemplary results comparing embodiments described herein to other knowledge distillation methods. The table shows that the method described herein achieves state-of-the-art results with different teacher and student network architectures on RAF-DB. The second to seventh columns are the results for Transformer-to-CNN KD, and the eighth column is the results for CNN-to-CNN KD. The student network in the 2nd, 5th, 6th, and 8th columns is MobileNetV2. As illustrated, the student's performance is much higher for the Transformer teacher compared to the CNN teacher. This result justifies the motivation to use a Transformer teacher instead of a CNN teacher during KD training stage. The method described herein outperforms MLD by more than 1% accuracy in most Transformer-to-CNN scenarios.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method of knowledge distillation from a teacher model to a student model, comprising:
encoding, via a first encoder, a feature of the student model to provide first principal components;
encoding, via a second encoder, a feature of the teacher model to provide second principal components;
decoding, via a first decoder, the first principal components to provide first decoded components;
decoding, via a second decoder, the second principal components to provide second decoded components;
computing first logits via the student model;
computing second logits from the teacher model;
computing a loss based on at least one of:
a comparison of the first principal components to the second principal components;
a comparison of the first decoded components to the feature of the student model;
a comparison of the second decoded components to the feature of the teacher model; or
a comparison of the first logits to the second logits; and
updating parameters of the student model based on the loss.
